(19) United States
(12) Patent Application Publication
(10) Pub. No.: US 2006/0022953 A1
(43) Pub. Date: Feb. 2, 2006

(54) Left-hand originated user interface control for a device

(75) Inventor: Tommi Franttila, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/903,503

(22) Filed: Jul. 30, 2004

(51) Int. Cl. G09G 5/00

(52) U.S. Cl. 345/173

(57) ABSTRACT

A method and apparatus are provided for adapting a user interface having at least one control item on a display of a device for controlling the user interface, wherein the at least one control item for controlling the user interface located on the right-handed side of the display is relocated to the left-handed side of the display in response to a request from a user. The device includes a touch screen control device having a touch screen for displaying the image and for touching to control the operation of the device, or other suitable device. The control item includes a scroll bar, virtual keyboard/writing area or other suitable icon for controlling the operation of the device.

### BACKGROUND OF THE INVENTION

1. Field Of Invention

The present invention relates to a method and apparatus for adapting a user interface having at least one control item on a display of a device for controlling the user interface; and more particularly to a method and apparatus for adapting a user interface having at least one control item on a display of a device for controlling the user interface with a left-handed or a right-handed mode of operation.

2. Description of Related Art

Many, if not most, devices are inherently designed with a right-handed bias to them. The primary reasons for this is likely to be that about 90% of the people in the human race are either genetically predisposed to being right-handed, behaviourly trained in their formative years to be right-handed, or both. Because of this, left-handed people clearly represent a minority in the human race, and the left-handed user of such right-handed biased devices experiences inherent problems with such devices that a right-handed user may not experience or even fundamentally appreciate.

For example, it is difficult for a left-handed user to use a touch-screen device, where most, if not all, of the controls (e.g. the scroll bar) are located on the right-handed side of the image on the display. The left hand of the user covers the display when using the device as shown in FIG. 1. For example, when a left-handed person is using the known device, the person faces a problem where their own hand hides the screen due to the fact that control items like scroll-bars and control buttons are in the right end of the display.

In one known prior art device, the user can change the orientation of the display to either a portrait mode, a right-handed landscape mode for right-handed users, or a left-handed landscape mode for left-handed users by either pressing a hardware button or using a menu option.

However, the known device merely turns the image on the display “upside down”, so that the hard keys are either on the left or right side of the display in relation to the image when viewed by the user. In other words, the orientation of the image is inverted about its horizontal axis by reversing the top side to the bottom side of the image. It does not adjust the user interface (UI) elements, such as scroll bars, so as to be optimized for touch screen left-handed usage.

The present invention provides a new and unique way to address this long felt problem in the art of right-handed biased devices and provide a solution thereto to optimize many such devices for more convenient left-handed usage.

### SUMMARY OF INVENTION

In its broadest sense, the present invention provides a solution to the aforementioned problem with a new and unique method and device for adapting a user interface having at least one control item on a display of the device for controlling the user interface, wherein the at least one control item for controlling the user interface located on the right-handed side of the display is relocated to the left-handed side of the display in response to a request from a user. The one or more control items located on the left-handed side of the display may be subsequently relocated back to the right-handed side of the display in response to a corresponding request from the user, and vice versa.

The device may include a touch screen control device having a touch screen for displaying the user interface and for touching to control the operation of the device, or other suitable devices such as a personal computer, laptop, personal digital assistant, etc.

The control item includes a scroll bar or other suitable icon for touching to control the operation of the device, as well as a virtual keyboard/writing area.

The device may have a setting in its control panel or a hardware button to enable a user to choose and switch between a left-handed or a right-handed mode of operation. The device may also have a procedure for prompting a user during an initial device set-up to request either a left-handed or a right-handed mode of operation as a default setting, an initial setting, or a combination thereof.

The device has a processing means or module for adapting a user interface having at least one control item for controlling the user interface on a display of the device, wherein the processing means or module relocates the at least one control item for controlling the user interface located on the right-handed side of the display to the left-handed side of the display in response to a request from a user. The processing means or module may include a processor or other suitable module for relocating the at least one control item.

In effect, the present invention provides a left-handed mode of operation for displays, where one or more user interface control items such as a scroll bar, virtual keyboard/writing area, etc. are optimized for left-handed usage. Each control item may be optimized by moving it to a respective preprogrammed relocation position, a respective user programmed relocation position, or some combination thereof.

The present invention also includes implementing the step(s) of the method via a computer program running in a processor or controller in such a mobile terminal, node or device, as well as a computer program product with a program code, which program code is stored on a machine readable carrier, for carrying out the step(s) of the aforementioned method when a computer program is run in a processor or control module of such a device.

This present invention makes it easier to configure and use a device such as a touch screen controlled device in a left-hand originated mode of operation.

### BRIEF DESCRIPTION OF THE DRAWING

The drawing, not drawn to scale, includes the following Figures:

FIG. 1 shows a diagram of a prior art touch screen device having control items on the right side of the screen or display.

FIG. 2 shows a diagram of a touch screen device according to the present invention.

FIG. 3 shows a block diagram of the touch screen device in FIG. 2 according to the present invention.

### DETAILED DESCRIPTION OF INVENTION

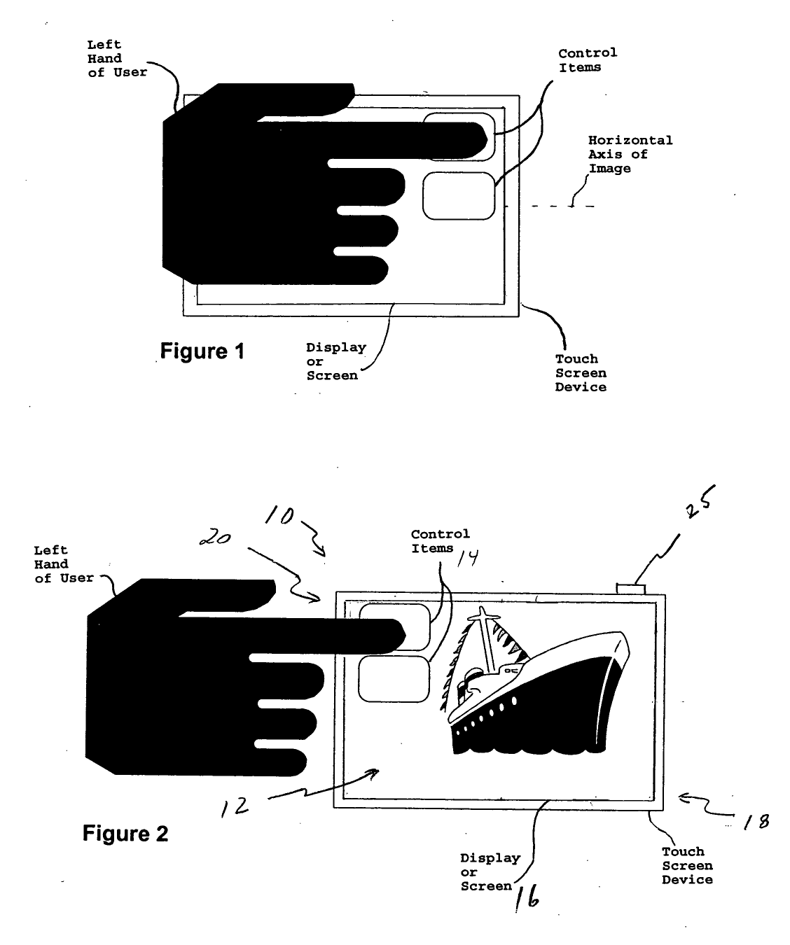

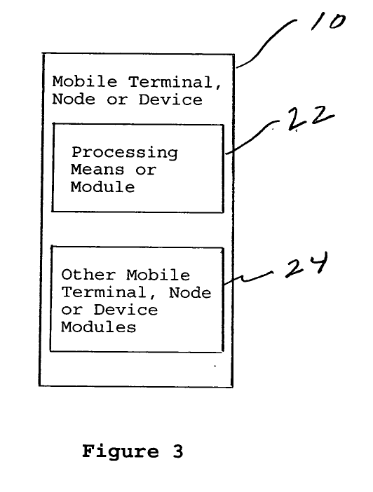

FIGS. 2 and 3 show a new and unique device generally indicated as 10 having a processing means or module 22 for adapting a user interface 12 having one or more control items 14 on a display 16 of the device 10 for controlling the user interface 12, wherein the processing means or module 22 relocates the one or more control items 14 located on the right-handed side 18 of the display 16 to the left-handed side 20 of the display 16 in response to a request from a user. (Compare the position of the control items shown in FIGS. 1-2 on the right-handed side 18 and the left-handed side 20 of the display 16.) The one or more control items 14 located on the left-handed side of the display may be subsequently relocated back to the right-handed side of the display in response to a corresponding request from the user, and vice versa.

The term “left-handed” side is intended to mean any place on the display 16 of the device 10 that is optimized for left-handed usage, and vice versa for the term “right-handed” side. In other words, according to the present invention, the one or more control items 14 located on the right-handed side 18 of the display 16 do not have to be relocated literally to the left side of the display 16, but may instead only be located in a position, for example, nearer to the left side than as otherwise positioned before being relocated. Moreover, the scope of the invention is intended to include each control item being optimized by moving it to a respective preprogrammed relocation position, a respective user programmed relocation position, or some combination thereof. A person skilled in the art would appreciate how to implement such embodiments in the processing means or module 22.

The device 10 may include a touch screen control device, as shown in FIGS. 1-2, in which the display or screen 16 is a touch screen for displaying the user interface 12 and for touching to control the operation of the device 10. The scope of the invention is intended to include other suitable touch control devices now known or later developed in the future.

The control item 14 is shown as a control button or icon 14, although the scope of the invention is not intended to be limited to any particular type or kind of control item. Embodiments of the invention are intended to include control items such as a scroll bar, virtual keyboard/writing area, other suitable icon, etc. for controlling the operation of the devices now known or later developed in the future.

The touch screen device 10 may have a setting in its control panel or a hardware button 25 to enable the user to request either a left-handed or a right-handed mode of operation.

The touch screen device 10 may also have one or more procedures for prompting the user during an initial device set-up to request either a left-handed or a right-handed mode of operation, as a default setting, an initial setting, or a combination thereof. A person skilled in the art would appreciate how to implement such embodiments in the processing means or module 22.

### Processing Means or Module 22

The functionality of the processing means or module 22 shown in FIG. 3 may be implemented using hardware, software, firmware, or a combination thereof. In a typical software implementation, the processing means or module 22 would be one or more microprocessor-based architectures having a microprocessor, a random access memory (RAM), a read only memory (ROM), input/output devices and control, data and address buses connecting the same. A person skilled in the art of programming would be able to program such a microprocessor-based implementation to perform the functionality described herein without undue experimentation. The scope of the invention is not intended to be limited to any particular implementation using technology known or later developed in the future.

### Other Device Modules 24

The device 10 may also include other device modules 24 that are known in the art, but do not necessarily form part of the basic invention disclosed herein, including a keyboard module, a memory module, input/output modules, a control module, etc.

### Scope of the Invention

The scope of the invention is not intended to be limited to any specific kind of device or user equipment, mobile terminal, phone or devices, and many different mobile terminals or devices, including laptop or notebook computers, as well as PDAs and tablet PCs, are envisioned that may contain the fundamental features of the present invention described herein.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method for adapting a user interface having at least one control item on a display of a device for controlling the user interface, characterized in that
the at least one control item for controlling the user interface located on the right-handed side of the display is relocated to the left-handed side of the display in response to a request from a user.

2. A method according to claim 1, wherein the device is a touch screen control device having a touch screen for displaying the user interface and for touching to control the operation of the device, or other suitable devices such as a personal computer, laptop, personal digital assistant, etc.

3. A method according to claim 1, wherein the at least one control item includes a scroll bar or other suitable icon for touching to control the operation of the device.

4. A method according to claim 1, wherein the device has a setting in its control panel or has a hardware button to enable the user to request either a left-handed mode of operation or a right-handed mode of operation.

5. A method according to claim 1, wherein the device includes one or more procedures for prompting the user during an initial device set-up to request either a left-handed or a right-handed mode of operation as a default setting, an initial setting, or a combination thereof.

6. A method according to claim 1, wherein the at least one control item includes a virtual keyboard/writing area.

7. A method according to claim 1, wherein the at least one control item located on the left-handed side of the display is relocated back to the right-handed side of the display in response to a corresponding request from the user.

8. A method according to claim 1, wherein the one or more control items are relocated to a respective preprogrammed relocation position, a respective user programmed relocation position, or some combination thereof.

9. A device having means for adapting a user interface having at least one control item on a display of a device for controlling the user interface, characterized in that
the means for adapting relocates the at least one control item for controlling the user interface located on the right-handed side of the display to the left-handed side of the display in response to a request from a user.

10. A device according to claim 9, wherein the device is a touch screen control device having a touch screen for displaying the user interface and for touching to control the operation of the device, or other suitable devices such as a personal computer, laptop, personal digital assistant, etc.

11. A device according to claim 9, wherein the at least one control item includes a scroll bar or other suitable icon for touching to control the operation of the device.

12. A device according to claim 9, wherein the device has a setting in its control panel or has a hardware button to enable a user to request either a left-handed mode of operation, or a right-handed mode of operation.

13. A device according to claim 9, wherein the device includes one or more procedures for prompting a user during an initial device set-up to request either a left-handed or a right-handed mode of operation as a default setting, an initial setting, or a combination thereof.

14. A device according to claim 9, wherein the at least one control item include a virtual keyboard/writing area.

15. A device according to claim 9, wherein the means relocates the at least one control item located on the left-handed side of the display back to the right-handed side of the display in response to a corresponding request from the user.

16. A device according to claim 9, wherein the means relocates the one or more control items to a respective preprogrammed relocation position, a respective user programmed relocation position, or some combination thereof.

17. A device according to claim 9, wherein the device is a mobile terminal or other suitable node.

18. A device according to claim 9, wherein the means for adapting includes a processing module.

19. A method according to claim 1, wherein the method further comprises implementing the step of the method via a computer program running in a processor or controller in a device.

20. A computer program product with a program code, which program code is stored on a machine readable carrier, for carrying out steps of a method for adapting a user interface having at least one control item on a display of a device for controlling the user interface, wherein the at least one control item for controlling the user interface located on the right-handed side of the display is relocated to the left-handed side of the display in response to a request from a user, when a computer program is run in a processor or control module of a device.
